(19) United States
(12) Patent Application Publication
(10) Pub. No.: US 2025/0336618 A1
(43) Pub. Date: Oct. 30, 2025

(54) APPARATUS AND SYSTEM FOR REMOTELY OPERATING A RESET SWITCH FOR ELECTRICAL EQUIPMENT

(71) Applicant: Duke Energy Corporation, Charlotte, NC (US)

(72) Inventors: Troy Bradfield, Lee, FL (US); Gian Framingheddu, New Port Richey, FL (US); Shiva Sainoju Korremla, Apex, NC (US); Christian Leeth Petit, Atlanta, GA (US); Timothy Ben Slay, Mooresville, NC (US)

(21) Appl. No.: 19/080,025

(22) Filed: Mar. 14, 2025

Related U.S. Application Data
(60) Provisional application No. 63/640,079, filed on Apr. 29, 2024.

(51) Int. Cl. H01H 9/00; H01H 3/02; H01H 3/32; H01H 9/16

(52) U.S. Cl. CPC H01H 9/0027; H01H 3/02; H01H 3/32; H01H 9/0044; H01H 9/167; H01H 2003/0266; H01H 2221/022; H01H 2223/016

(57) ABSTRACT

A system for remotely operating a control panel reset switch for electrical equipment includes a remote control device, and a portable apparatus in communication with the remote control device. The portable apparatus includes a housing configured to be removably attached to the control panel and an electromagnetic actuator attached to the housing. The electromagnetic actuator includes a solenoid with a plunger. A rod is attached to the plunger and is movable through an opening in the housing from a retracted position to an extended position when the solenoid is energized. The rod contacts and operates the reset switch when in the extended position. The portable apparatus includes a camera that acquires images of the rod and reset switch during operation. The remote control device includes a switch for operating the electromagnetic actuator and at least one display configured to display operational messages and images from the camera.

### RELATED APPLICATION

This application claims the benefit of and priority to U.S. Provisional Patent Application No. 63/640,079 filed Apr. 29, 2024, the disclosure of which is incorporated herein by reference as if set forth in its entirety.

### FIELD OF THE INVENTION

The present invention relates generally to electrical power generation and, more particularly, to electrical power grid equipment.

### BACKGROUND OF THE INVENTION

Load tap changers are mounted directly to sub-station transformers and are used to control output voltage levels of these transformers in finite increments while they are supplying load current. Load tap changers operate by connecting to different access points, known as taps, along either the primary or secondary windings of a transformer. Output voltage of a transformer is regulated by altering the number of turns in one winding, thus changing the turns ratio of the transformer.

Typically, load tap changers are protected by a Vacuum Interrupter Failure (VIP) monitoring system. If the monitoring system reaches an alarm state, the monitoring system will prevent the load tap changer from operating. However, the load tap changer can be reset by use of a reset toggle switch associated with the monitoring system on a transformer.

FIG. 1 illustrates a monitoring system control panel 10 for an LRT-200 load tap changer manufactured by General Electric. The control panel 10 includes a fault indicator light 12, a test switch 14, and a reset toggle switch 16. However, operation of the reset toggle switch 16 while a transformer is energized may be dangerous because a worker is required to be in close proximity with the energized transformer, which may be operating at voltages of 15 kV and above. As such, current safety practices typically require that an energized transformer be de-energized before being reset. Unfortunately, de-energizing a transformer at a substation would cause an electrical outage to customers, so a portable substation must be installed to prevent customer outages. The installation of a portable substation is a costly activity due to transport, assembly, commissioning, and maintenance costs that can exceed $200,000 per installation, along with the initial portable substation purchase of around $2,500,000.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

The present invention includes a portable device that will magnetically attach (or use one or more adhesive command strips to attach) to a surface adjacent a reset switch (e.g., a toggle switch). The portable device has a small footprint that allows it to fit in tight spaces, but also has the power to give sufficient pressure to a toggle switch and then allow the switch to bounce back to a resting position. A remote control device is in electrical communication with the portable apparatus, either via a cable or wirelessly, and allows a technician to operate the reset switch from a safe distance, e.g., at least 75 ft away, etc.

Embodiments of the present invention are advantageous because worker safety can be improved by allowing technicians to stand a safe distance away from an energized transformer while resetting the transformer. Furthermore, embodiments of the present invention avoid the need for installing a mobile substation in order to de-energize a substation transformer, which results in time and cost savings.

According to some embodiments of the present invention, a portable apparatus for remotely operating a reset switch for electrical equipment, such as a transformer load tap changer, includes a housing configured to be removably attached to a control panel of the electrical equipment. A rod is movably secured to the housing and is movable through an opening in the housing between a retracted position and an extended position. The rod is configured to contact and operate the reset switch when moved to the extended position, and then quickly retract so that the reset switch can move back to a resting position. An actuator is attached to the housing and is configured to move the rod between the retracted and extended positions in response to a control signal received from a remote device.

In some embodiments, the housing includes at least one magnet, and the housing is magnetically attached to the control panel via the at least one magnet.

In some embodiments, the rod includes a plate at a distal end thereof. The plate is configured to contact and operate the reset switch when the rod is moved to the extended position. The plate is in face-to-face, closely-adjacent relationship with the housing when in the retracted position.

In some embodiments, a camera is attached to the housing and is configured to acquire images of the rod and reset switch during movement of the rod. The camera may be movably attached to the housing, for example, via a hinge.

In some embodiments, the actuator is configured to receive the control signal wirelessly from a remote device or via a cable in electrical communication with the remote device.

According to other embodiments of the present invention, a portable apparatus for remotely operating a control panel reset switch for a transformer load tap changer includes a housing configured to be removably attached to a control panel of the transformer load tap changer. An electromagnetic actuator is attached to the housing and includes a solenoid with a plunger. A rod is attached to the plunger and is movable through an opening in the housing from a retracted position to an extended position when the solenoid is energized in response to a control signal. The rod is configured to contact and operate the reset switch when in the extended position, and then quickly retract so that the reset switch can move back to a resting position.

In some embodiments, the solenoid includes a spring that is configured to urge the plunger and the rod attached thereto to the retracted position when the solenoid is not energized.

In some embodiments, the housing includes at least one magnet, and the housing is magnetically attached to the control panel via the at least one magnet.

In some embodiments, a plate is secured to a distal end portion of the rod. The plate is configured to contact and operate the reset switch when the rod is moved to the extended position. The plate is in face-to-face, closely-adjacent relationship with the housing when in the retracted position.

In some embodiments, a camera is attached to the housing and is configured to acquire images of the rod and reset switch during operation of the portable apparatus.

In some embodiments, the electromagnetic actuator is configured to receive the control signal wirelessly from a remote device or via a cable from the remote device.

According to some embodiments of the present invention, a system for remotely operating a control panel reset switch for a transformer load tap changer, includes a remote control device and a portable apparatus configured to communicate with the remote control device. The portable apparatus includes a housing configured to be removably attached to a control panel of the transformer load tap changer. An electromagnetic actuator is attached to the housing and includes a solenoid with a plunger. A rod is attached to the plunger and is movable through an opening in the housing from a retracted position to an extended position when the solenoid is energized. The rod is configured to contact and operate the reset switch when in the extended position, and then quickly retract so that the reset switch can move back to a resting position.

In some embodiments, the solenoid includes a spring that is configured to urge the plunger and rod to the retracted position when the solenoid is not energized.

In some embodiments, the housing includes at least one magnet, and the housing is magnetically attached to the control panel via the at least one magnet.

In some embodiments, a plate is secured to a distal end portion of the rod, and the plate is configured to contact and operate the reset switch when the rod is moved to the extended position. The plate is in face-to-face, closely-adjacent relationship with the housing when the rod is in the retracted position.

In some embodiments, the remote control device includes an on/off switch configured to connect or disconnect power to the portable apparatus, a switch for operating the electromagnetic actuator, and a display configured to display operational messages. In some embodiments, the remote control device includes at least one display configured to display operational messages and to display images from a camera attached to the housing. The camera is configured to acquire images of the rod and reset switch during operation of the portable apparatus.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates a monitoring system control panel for a substation transformer.

FIGS. 2A-2B illustrate a system for remotely operating a control panel reset switch for electrical equipment, according to some embodiments of the present invention.

FIG. 3 is a top perspective view of the portable switch operator of the system illustrated in FIGS. 2A-2B.

FIG. 4 is a top view of the remote control device of the system illustrated in FIGS. 2A-2B.

FIGS. 5A-5D illustrate a sequence of activating a reset switch using the system of FIGS. 2A-2B.

### DETAILED DESCRIPTION OF THE INVENTION

The present invention will now be described more fully hereinafter with reference to the accompanying figures, in which embodiments of the present invention are shown. The present invention may, however, be embodied in many different forms and should not be construed as limited to the embodiments set forth herein.

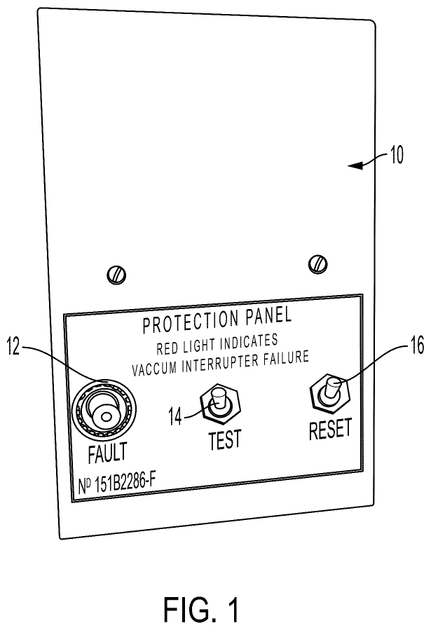

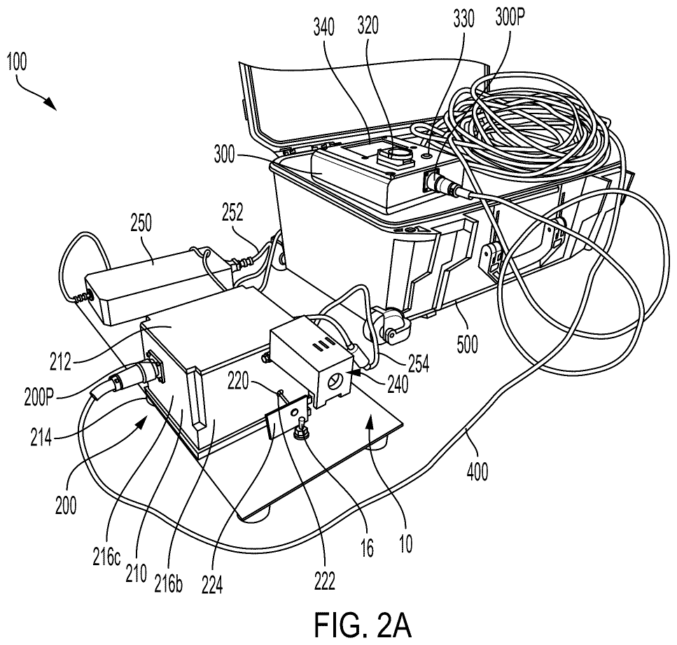

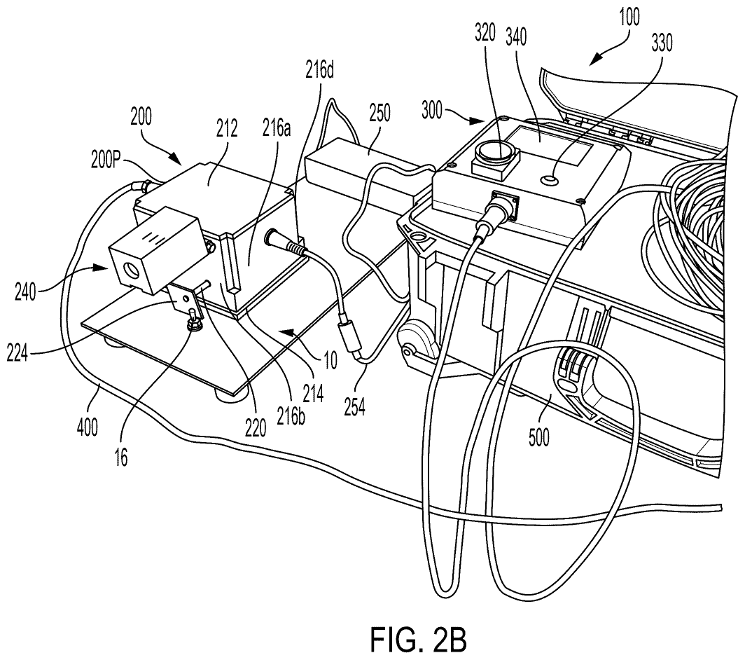

Referring to FIGS. 2A-2B, a system 100 for remotely operating a control panel reset switch (e.g., the substation transformer reset switch 16 of FIG. 1, etc.) includes a portable switch operator apparatus 200 and a remote control device 300. In the illustrated embodiment, the portable apparatus 200 is in electrical communication with the remote control device 300 via a cable 400 that attaches at one end to the portable apparatus 200 at port 200p and attaches at the opposite end to the remote control device 300 at port 300p. However, in other embodiments, the portable switch operator 200 may be in communication with the remote control device 300 wirelessly, and no cable is utilized.

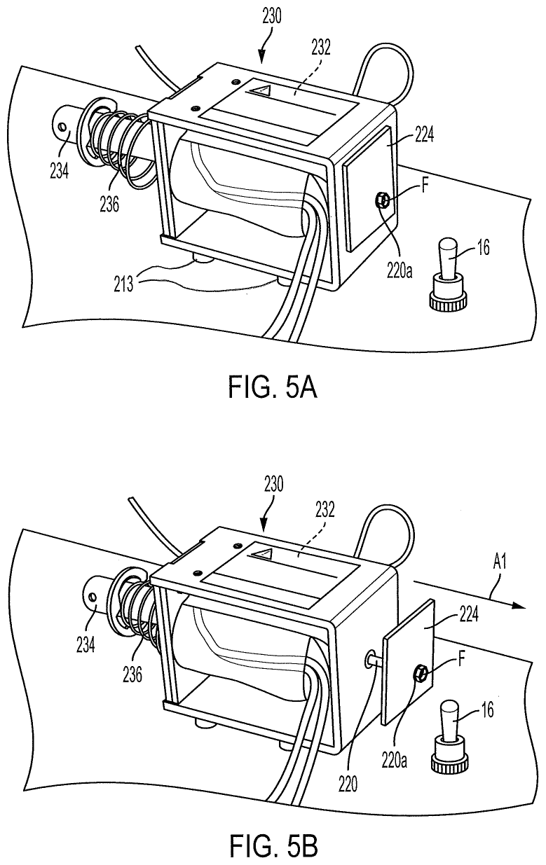

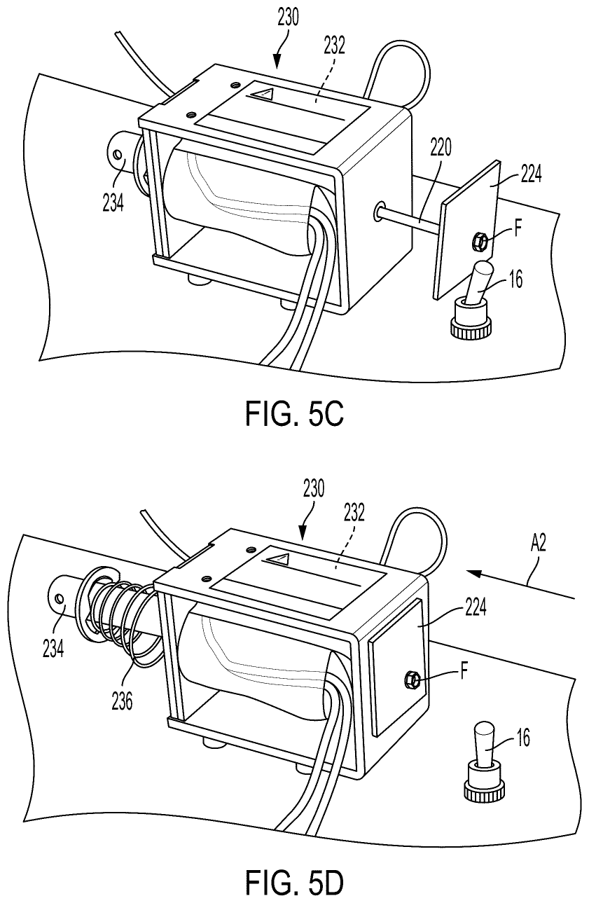

The illustrated portable apparatus 200 includes a housing 210 that is configured to be removably attached to a control panel 10 or other surface to which a reset switch (e.g., reset switch 16) is attached or near. The housing 210 may be formed from non-conductive material, such as a non-conductive polymeric material, and may have a small footprint enabling the portable apparatus 200 to be used in tight spaces (e.g., confined or narrow areas with limited room for movement, access, or maneuverability). The housing 210 is configured to house a plunger 220, an actuator 230 (FIGS. 5A-5D), one or more controllers, and various other electrical components required for operation of the portable apparatus 200.

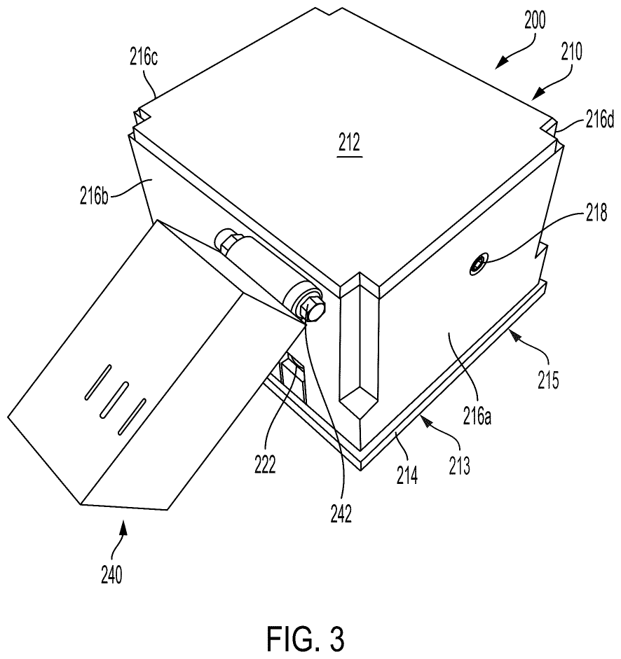

Referring to FIG. 3, the illustrated housing 210 has a generally cube shape with a top wall 212, a bottom wall 214, and side walls 216a-216d. However, embodiments of the present invention are not limited to the illustrated configuration of the housing 210. The housing 210 may have various shapes and configurations.

Typically, control panels and other surfaces to which reset switches for electrical equipment are mounted are formed of metal. As such, in some embodiments, the bottom wall 214 of the housing 210 may include one or more magnets 213 attached thereto so that the housing 210 can be magnetically attached to the metal surface of the control panel (e.g., control panel 10) or another nearby surface. The one or more magnets 213 may have various sizes, shapes and configurations. In some embodiments, the bottom wall 214 or at least a portion of the bottom wall 214 may be magnetic. In other embodiments, the housing 210 may be adhesively attached to the control panel, for example, via one or more adhesive strips 215 attached to the bottom wall 214 of the housing 210.

A rod 220 (FIGS. 2A-2B) is associated with the actuator 230 (FIGS. 5A-5D) within the housing 210 and is extendable through an opening 222 in the housing 210. As will be described below, the rod 220 is movable between a retracted position (FIG. 5A) and an extended position (FIG. 5C). In the illustrated embodiment, a plate 224 is secured to a distal end portion 220a of the rod 220 and is configured to contact and operate the reset switch 16 when the rod 220 is moved to the extended position. When in the retracted position, the plate 224 is in face-to-face, closely-adjacent relationship with side wall 216b of the housing 210. In some embodiments, when in the retracted position, the plate 224 may be in face-to-face contacting relationship with the side wall 216b.

The portable apparatus 200 is removably attached to a control panel 10 or other surface in close proximity to a reset switch, for example within a distance of between one and six inches (1″-6″). However, embodiments of the present invention are not limited to this range. Typically, the rod 220 is configured to move between about one a three inches (1″-3″) to activate a reset switch.

In the illustrated embodiment, the plate 224 is secured to the distal end portion of the rod 220 via a fastener F, such as a threaded fastener (e.g., a bolt or screw), a rivet, etc. The illustrated plate has a generally rectangular shape and may have a length and width of between about one inch and three inches (1″-3″). However, embodiments of the present invention are not limited to the illustrated shape and configuration of the plate. The plate 224 may have various sizes, shapes and configurations, and may be secured to the distal end portion 220a of the rod 220 in various ways. In some embodiments, the rod 220 and plate 224 may be a single, monolithic element.

In the illustrated embodiment, the actuator 230 (FIGS. 5A-5D) is located within the housing 210 and is configured to move the rod 220 between the retracted and extended positions in response to a control signal received from the remote device 300. However, in other embodiments, the actuator 230 may be located partially or entirely outside of the housing 210. In the illustrated embodiment, the actuator 230 is an electromagnetic actuator that includes a solenoid 232 with a plunger 234. The rod 220 is attached to the solenoid plunger so as to be movable with the plunger 234. The plunger 234 is movable in response to the solenoid 232 being energized. Thus, when the solenoid 232 is energized, the rod 220 is moved to the extended position (FIG. 5C). The illustrated actuator 230 also includes a spring 236 that is configured to urge the solenoid plunger 234, and the rod 220 attached thereto, to the retracted position when the solenoid 232 is no longer energized.

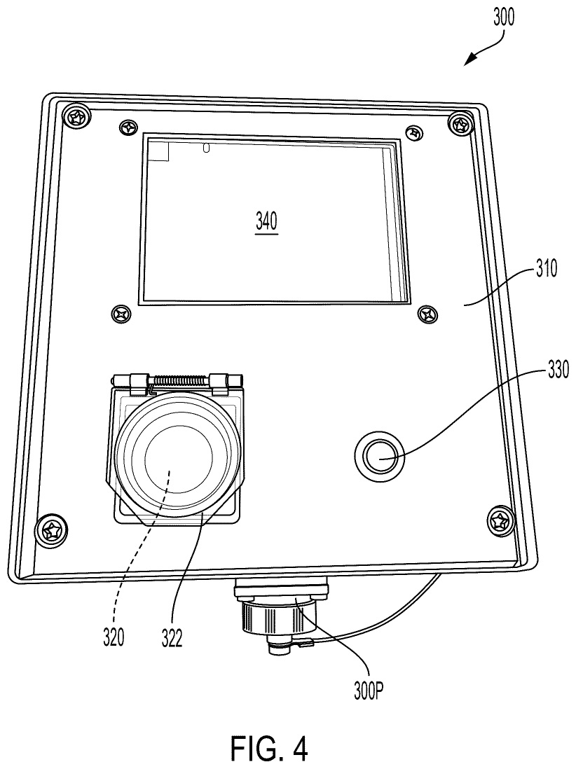

FIGS. 5A-5D illustrate a sequence of activating a reset switch 16 via the actuator 230. In FIG. 5A, the solenoid 232 of the actuator 230 is not energized and the plunger 234 and rod 220 attached thereto are in the retracted position. In FIG. 5B, a technician has energized the solenoid via the remote control device 300 (FIG. 4) and the plunger 234 and rod 220 attached thereto are moved in direction A₁ toward the reset switch 16. In FIG. 5C, the plunger 234 and rod 220 are at the extended position such that the plate 224 has moved the reset switch 16. Upon being deenergized, the plunger 234 and rod 220 move quickly in direction A₂ to the retracted position illustrated in FIG. 5D, for example, under the biasing force of the spring 236. The plunger 234 and rod 220 are configured to move quickly away from the reset switch 16 to allow the reset switch 16 to move back to a resting position.

The portable apparatus 200 may also include a camera 240 attached thereto that is configured to acquire images of the rod 220, the plate 224, and the reset switch 16 during operation of the portable apparatus 200. In the illustrated embodiment, the camera 240 is movably secured to side wall 216b of the housing 210 via a movable connector 242, such as a hinge, so as to be adjustable to ensure that the reset switch 16 and rod are in the field of view of the camera 240.

In some embodiments, only the electromagnetic actuator 230 illustrated in FIGS. 5A-5D may be mounted to a control panel adjacent a reset switch 16. The other components/electronics of the portable apparatus 200 are relocated into a separate housing that can be located at the bottom of a control panel, for example. This would greatly cut down the size and allow more flexibility for multiple applications. The electromagnetic actuator 230 can be attached to the control panel via one or more magnets 213, for example.

Referring to FIG. 4, the illustrated remote control device 300 includes a top panel 310 with an on/off switch 320 configured to connect or disconnect power to the portable apparatus 200, a switch 330 for operating the electromagnetic actuator 230, and a display 340 configured to display operational messages. For example, the display 340 may display a warning message to clear the area prior to operating a transformer reset switch. The display 340 may also be configured to display images from the camera 240, for example, of the reset switch 16, and the rod and plate 220, 224. In other embodiments, a separate display may be provided for displaying images from the camera 240. In the illustrated embodiment, a hinged cover 322 is provided over the on/off switch 320 to prevent inadvertent actuation of the on/off switch 320. The hinged cover 322 includes a biasing member 324, such as a spring, that is configured to urge the cover to a position overlying the on/off switch 320.

In some embodiments, the remote control device 300 may be configured to provide an audible notification once the electromagnetic actuator 230 has completed its operation. For example, the audible notification may be a continuous sound for a predetermined time, an alternating sound for a predetermined time, a voice message, etc. In some embodiments, the remote control device 300 may be configured to provide a visual notification once the electromagnetic actuator 230 has completed its operation, such as an indicator light, a message on the display 340, etc.

Referring back to FIGS. 2A-2B, a power supply device 250 may be provided to provide power to the portable apparatus 200 and to the remote control device 300 from a power source. In the illustrated embodiment, the power supply device 250 has a first cable 252 configured to be connected to an AC power source. The power supply device 250 converts the AC power to DC power and a second cable 254 provides DC power to the apparatus 200 and remote control device 300 (when attached to the apparatus 200 via cable 400) via a power port 218 accessible through the sidewall 216a of the housing 210.

A case 500 may be provided to house the portable apparatus 200, the remote control device 300, the cable 400, and the power supply device 250, as illustrated in FIGS. 2A-2B. In some embodiments, a power source for providing power to the portable apparatus 200 and the remote control device 300 may be provided within the case. The case 500 allows for the components of the system 100 to be easily transported for use at different locations.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. The term “and/or” includes any and all combinations of one or more of the associated listed items.

Like numbers refer to like elements throughout. In the figures, certain components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such. 30

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected”, “coupled”, “responsive”, or variants thereof to another element, it can be directly connected, coupled or responsive to the other element or intervening elements may be present. In contrast, when an element is referred to as being “directly connected”, “directly coupled”, “directly responsive”, or variants thereof to another element, there are no intervening elements present. Other words used to describe the relationship between elements should be interpreted in a like fashion (i.e., “between” versus “directly between”, “adjacent” versus “directly adjacent”, etc.).

As used herein, the singular forms “a”, “an” and “the” are intended to include the plural forms as well, unless the context clearly indicates otherwise. As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present invention. The same reference numerals or the same reference designators denote the same or similar elements throughout the specification.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terms “about” and “approximately”, as used herein with respect to a value or number, is meant to encompass variations of ±10%, ±5%, ±1%, ±0.5%, or even±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A portable apparatus for remotely operating a reset switch for electrical equipment, the apparatus comprising:
a housing configured to be removably attached to a control panel of the electrical equipment;
a rod movably secured to the housing and movable through an opening in the housing between a retracted position and an extended position, wherein the rod is configured to contact and operate the reset switch when moved to the extended position; and
an actuator attached to the housing, wherein the actuator is configured to move the rod between the retracted and extended positions in response to a control signal received from a remote device.

2. The apparatus of claim 1, wherein the housing comprises at least one magnet, and wherein the housing is magnetically attached to the control panel via the at least one magnet.

3. The apparatus of claim 1, wherein the rod comprises a plate at a distal end thereof, and wherein the plate is configured to contact and operate the reset switch when the rod is moved to the extended position, and wherein the plate is in face-to-face, closely-adjacent relationship with the housing when in the retracted position.

4. The apparatus of claim 1, further comprising a camera movably attached to the housing, wherein the camera is configured to acquire images of the rod and reset switch during movement of the rod.

5. The apparatus of claim 1, wherein the actuator is configured to receive the control signal wirelessly from a remote device or via a cable in electrical communication with the remote device.

6. The apparatus of claim 1, wherein the control panel reset switch is a reset switch for a transformer load tap changer.

7. A portable apparatus for remotely operating a control panel reset switch for a transformer load tap changer, the apparatus comprising:
a housing configured to be removably attached to a control panel of the transformer load tap changer; and
an electromagnetic actuator attached to the housing, the electromagnetic actuator comprising a solenoid with a plunger, wherein a rod is attached to the plunger and is movable through an opening in the housing from a retracted position to an extended position when the solenoid is energized in response to a control signal, and wherein the rod is configured to contact and operate the reset switch when in the extended position.

8. The apparatus of claim 7, wherein the solenoid further comprises a spring that is configured to urge the plunger and the rod attached thereto to the retracted position when the solenoid is not energized.

9. The apparatus of claim 7, wherein the housing comprises at least one magnet, and wherein the housing is magnetically attached to the control panel via the at least one magnet.

10. The apparatus of claim 7, further comprising a plate secured to a distal end portion of the rod, wherein the plate is configured to contact and operate the reset switch when the rod is moved to the extended position, and wherein the plate is in face-to-face, closely-adjacent relationship with the housing when in the retracted position.

11. The apparatus of claim 7, further comprising a camera movably attached to the housing, wherein the camera is configured to acquire images of the rod and reset switch during operation of the portable apparatus.

12. The apparatus of claim 7, wherein the electromagnetic actuator is configured to receive the control signal wirelessly from a remote device.

13. The apparatus of claim 7, wherein the electromagnetic actuator is configured to receive the control signal via a cable in electrical communication with a remote device.

14. A system for remotely operating a control panel reset switch for a transformer load tap changer, the system comprising:
a remote control device; and
a portable apparatus configured to communicate with the remote control device, the portable apparatus comprising:
a housing configured to be removably attached to a control panel of the transformer load tap changer; and
an electromagnetic actuator attached to the housing, the electromagnetic actuator comprising a solenoid with a plunger, wherein a rod is attached to the plunger and is movable through an opening in the housing from a retracted position to an extended position when the solenoid is energized, and wherein the rod is configured to contact and operate the reset switch when in the extended position.

15. The system of claim 14, wherein the solenoid further comprises a spring that is configured to urge the plunger and rod to the retracted position when the solenoid is not energized.

16. The system of claim 14, wherein the housing comprises at least one magnet, and wherein the housing is magnetically attached to the control panel via the at least one magnet.

17. The system of claim 14, further comprising a plate secured to a distal end portion of the rod, wherein the plate is configured to contact and operate the reset switch when the rod is moved to the extended position, and wherein the plate is in face-to-face, closely-adjacent relationship with the housing when in the retracted position.

18. The system of claim 14, wherein the remote control device comprises an on/off switch configured to connect or disconnect power to the portable apparatus, a switch for operating the electromagnetic actuator, and a display configured to display operational messages.

19. The system of claim 14, wherein the portable apparatus further comprises a camera movably attached to the housing, and wherein the camera is configured to acquire images of the rod and reset switch during operation of the portable apparatus.

20. The system of claim 19, wherein the remote control device comprises an on/off switch configured to connect or disconnect power to the portable apparatus, a switch for operating the electromagnetic actuator, and at least one display configured to display operational messages and to display images from the camera.

21. The system of claim 14, wherein the remote control device is configured to provide an audible and/or visual notification when the electromagnetic actuator has completed its operation.
